(19) United States
(12) Patent Application Publication
(10) Pub. No.: US 2008/0206001 A1
(43) Pub. Date: Aug. 28, 2008

(54) CUTTING TOOL

(75) Inventor: Lutfi Bozkurt, Winterlingen (DE)

Correspondence Address: BURR & BROWN, PO BOX 7068, SYRACUSE, NY, 13261-7068, US

(73) Assignee: Joerg GUEHRING, Albstadt (DE)

(21) Appl. No.: 12/059,326

(22) Filed: Mar. 31, 2008

Related U.S. Application Data
(63) Continuation of application No. PCT/DE2006/001740, filed on Oct. 4, 2006.

(30) Foreign Application Priority Data
Oct. 4, 2005 (DE) 102005047510.8

(51) Int. Cl. B26D 3/00

(52) U.S. Cl. 407/32

(57) ABSTRACT

A tool for cutting machining, such as drilling, milling, or friction machining preferably includes a tool head, and a tool shaft having a clamping section for housing in a tool support. The tool head includes a plurality of tool cutting edges that are arranged circumferentially about the tool head and that consist of the material of the tool head. The tool head can be fitted to the to the tool shaft as a separate part or can be intregally formed as part of the tool shaft. The tool head consists of, in one piece, a hard material and at least one functional layer comprising cubic boron nitride or polycrystalline diamond.

### CROSS-REFERENCE TO RELATED APPLICATION

This application is a continuation of International Application No. PCT/DE2006/001740 having an international filing date of Oct. 4, 2006 under PCT Article 21(2), the entirety of which is incorporated herein by reference.

### FIELD OF THE INVENTION

This invention relates to a tool for cutting machining, in particular, a tool for drilling, milling or friction machining.

### BACKGROUND OF THE INVENTION

Tools for cutting machining having a tool head and a tool shaft with a clamping section for housing in a tool support are known in a wide variety of forms. To guarantee high production qualities the tool must be matched to the prevailing operating parameters. In particular, a cutting tool must be suitable for machining predetermined materials or must be able to meet the cutting parameters required. In drilling, for example, relatively high cutting speeds and feed rates may be required. These tools must generally be available within a wide range of different diameter dimensions and should, in particular, be capable of relatively high mechanical and thermal loading.

Tool heads of the prior art were produced using relatively expensive techniques. For example, receiving grooves had to be worked into a base body of the tool head for the placement separate cutting tips, each having a cutting edge, at suitable points. The dimensions of the recesses must be adapted exactly to the dimensions of the cutting tips that are to be placed against the recesses. Then, suitably pre-machined cutting tips or the like are then securely fastened into the grooves. These cutting tips must include cutting edges that also have to be formed with a high dimensional stability. Further, if the cutting tips or the like are screwed onto the base body, bores must also be inserted in the cutting tips and the in base body of the tool head so that the tips can be fastened to the receiving grooves by screwing after the cutting tips are inserted in the recesses. Even if no screws are used, a glued connection is often used between the cutting tips and the base body, the glued connection being achieved by soldering, welding, gluing or the like. This procedure is generally expensive both technically and economically.

### SUMMARY OF THE INVENTION

The object of the invention is to provide a tool for cutting machining whose applications can be extended, where comparatively high production qualities are achievable. In particular, the tool should have a comparatively high wear resistance even when extremely resistant materials are being machined.

In accordance with one embodiment of the present invention, a tool is provided for cutting machining, in particular a tool for a drilling, milling or friction machining. Preferably, the tool includes a tool head with tool cutting edges consisting of the material of the tool head, and a tool shaft with a clamping section for housing in a tool support. An important aspect of the invention is that the tool head is fitted to the tool shaft as a separate part and consists of one piece of a hard material, such as a hard metal (e.g. solid carbide), with at least one functional layer which comprises a super-hard material, for example cubic boron nitride (CBN) or polycrystalline diamond (PCD). Using such materials, a comparably highly resistant tool in terms of mechanical or thermal stress may therefore be provided for drilling, milling or friction machining. For these purposes, the tool head need not be composed of several parts, but may consist of only one component. In particular, no separate cutting tips or the like are required, each of which receiving one functional layer or consisting monolithically of CBN or PCD Instead, the entire tool head, including all of the cutting edges, is produced from the hard material comprising the functional layer. Preferably this obviates the need to provide and subsequently fit the individual cutting tips to the tool head.

The tool head, subjected to particularly high stresses, has an enormous wear resistance because of the functional layer, even when highly resistant materials are machined. In the simplest case exactly one functional layer of CBN or PCD may be provided or the entire tool head may consist monolithically of CBN or PCD.

If necessary longer service distances or service lives can be achieved with the proposed tool compared to tools hitherto used. For example, a functional layer of a super-hard material, such as CBN or PCD, can be combined with a carrier material made of a hard metal, such as solid carbide, such that the functional layer has a higher wear resistances than a ceramic, cermet or solid carbide material that is to be machined. Several CBN or PCD functional layers may also be formed, for example, in different thicknesses or strengths.

In principle a functional layer, and if necessary the entire head, may consist fully or uniformly of CBN or PCD, or even of several components with a main component of CBN or PCD. For example, CBN or PCD particles may be distributed in a binding or carrier material and produced, for example, by power metallurgical sintering.

The at least one functional layer may be applied in the form of a coating or may be designed as a continuous layer in the tool head. Where there is a plurality of functional layers, they may be fixedly connected to each other or may be designed with one layer of a different hard material. In the case of smaller tool head diameters of less than approx. 6 mm, in particular, it may be advantageous for the tool head to consist almost completely, or even completely, of one material. For example it may be advantageous for the tool head to be formed from the functional layer of CBN or PCD, or for it to be connected to a solid carbide carrier.

In accordance with another embodiment of the present invention, a tool is provided for cutting machining, in particular a drilling, milling or friction machining, that includes a tool head with tool cutting edges consisting of the material of the tool head, the tool head having an outside diameter of up to 6 mm, and a tool shaft with a clamping section for housing in a tool support. Preferably, the tool head is fitted to the tool shaft as a separate part and has at least four tool cutting edges arranged around the circumference of the tool head. Therefore highly efficient drilling, milling or friction machining tools may be made available even in the case of comparatively very small tool head diameters. In particular, it is, therefore, economically possible to provide four or more tool cutting edges for hole diameters of 6 mm or smaller, for example, which was not previously practicable due to the relatively small tool head dimensions. Due to the comparatively higher number of tool cutting edges an associated higher machining quality for the holes of 6 mm and smaller, or better circumferential guidance of the tool in the material to be machined may also be achieved. The tool head may be advantageously produced because of the single-piece nature of the head. In particular, the tool head may be produced or formed independently of the tool shaft.

Preferably, the tool head consists of a hard material with at least one functional layer of CBN or PCD. The tool head according to the present embodiment is able to meet the most stringent requirements regarding wear resistance due to the functional layer, and in this case the required toughness of the tool head is achieved, for example, by a suitable hard material provided with a functional layer.

A functional layer of CBN or PCD can already produce a significant improvement as far as these properties are concerned. In principle, however, a plurality of different layers or different thicknesses of functional layers are also conceivable in the tool head combined with one or a plurality of carrier material(s). Preferably, a two-layer tool head consists, on the side directed towards the tool shaft, of a layer of solid carbide with a fixedly connected front layer of CBN. A homogeneous structure of the head from a functional layer, which comprises super-hard material, or consists completely of the super-hard material, is also conceivable.

Preferably, the layers are to be sintered together in a layer structure of the hard material, thus providing an extremely solid layer compound in the tool head and hence high stability. In particular, sinter materials that can be advantageously used with it can be brought to the finished structural form and can at the same time be permanently fixed in the layer structure.

In accordance with one embodiment of the present invention, the tool head is designed with a recess for fitting onto the tool shaft. Preferably, an insert section of the tool shaft is inserted into the recess of the tool head to connect the tool head to the tool shaft. This enables the tool head to be fitted securely and comparatively easily to the tool shaft. For example, the recess can be a simple pocket hole drilling in the tool head, and the insert section can be a suitably designed pin section at an end of the tool shaft. By means of a simple stick-on process a retaining seat can even be obtained in which the tool head can be accurately aligned and then securely fixed to the tool shaft by suitable connection techniques. Such techniques are well known in the art and include soldering, sintering, welding, brazing or gluing methods for example.

In accordance with another embodiment of the present invention, a tool is provided that includes a remachining unit formed on the tool shaft at a certain distance from the tool head in the longitudinal direction of the tool. For example, the tool head may be designed as a drill head and a reamer head matched to the bore diameter can be provided on the tool shaft slightly offset in the direction of the clamping section for remachining the bore. A bore can therefore be produced in one stroke and remachining of the inner wall of the bore can be carried out by friction over part of the bore depth.

In accordance with one embodiment of the present invention, a method is provided for producing a tool head for a tool for cutting machining, capable of being fixed to a tool shaft, particularly for producing a tool head for one of the above-mentioned tools. Preferably, the tool head is produced from a hard material blank, the tool head being machined by remachining the hard material blank, in particular by grinding partial areas to form a finished contour of the tool head. This enables the tool head to be produced extremely easily. In particular, the tool head consists of one piece, for example one material or of a plurality of materials, for example it may be worked out of a base material in the layered structure.

Previously, tool heads generally had to be produced relatively expensively. For example, receiving grooves had to be are worked into a base body of the tool head for the cutting edges at suitable points, which must be adapted exactly to the cutting edge dimensions to be introduced. Then, suitably pre-machined cutting tips or the like are then securely fastened into the grooves. These cutting tips must include cutting edges that also have to be formed with a high dimensional stability. Further, if the cutting tips and the like are screwed onto the base body, bores must also be inserted in the cutting tips and the base body of the tool head so that the tips can be fastened to the receiving grooves by screwing after the cutting tips are inserted. Even if no screws are used, a glued connection is often used between the cutting tips and the base body, the glued connection being achieved by soldering, welding, gluing or the like. This procedure is generally expensive both technically and economically. By providing the hard material blank according to the invention, where a basic shape of the tool head or a mould approaching very close to the final shape of the tool head is used, the production can be greatly simplified.

In accordance with one embodiment of the present invention, a method is provided that includes fixing the tool head to the tool shaft in the form of the hard material blank and machining the tool head to produce the finished contour. The blank tool head fixed to the tool shaft can therefore be remachined very accurately. This is advantageous in respect of the orientation of the ground surfaces and edges here the finished tool is concerned. Because of the secure fixing of the tool head, the tool head is in its final position on the tool shaft and can, in particular, be ground exactly symmetrically or rotationally symmetrically to the longitudinal axis of the tool.

For the finish machining of cutting edges and/or rakes on the tool head it may be advantageously sufficient for the hard material blank to be ground only.

Tool head regions, surfaces or edges, which must be extremely dimensionally accurate, can therefore be obtained with high precision and in a practicable manner.

In accordance with one embodiment of the present invention, a method is provided that includes working the hard material blank out from a hard material plate. The hard material plate may comprise a CBN or PCD functional layer or may consist monolithically of CBN or PCD. The initial shape for further processing into the hard material blank can be provided comparatively economically and advantageously. It is particularly appropriate for the hard material blank to be worked out of a plate-type material, e.g. by erosion or laser cutting.

### BRIEF DESCRIPTION OF THE DRAWINGS

Further features and advantages of the invention are described in the figures shown in the drawing.

In particular,

FIG. 1 shows a reamer according to one embodiment of the present invention in a side view;

FIG. 2 shows a front view of the reamer shown in FIG. 1 in arrow direction P1 viewed according to FIG. 1;

FIG. 3a shows a reamer head of the reamer shown in FIG. 1 in a bottom view;

FIG. 3b shows the reamer head according to FIG. 3a in section along line of intersection A-A from FIG. 1;

FIG. 4 shows a support part of the reamer shown in FIG. 1 in a side view;

FIG. 5 shows a front view of the support part shown in FIG. 4 in arrow direction P2 viewed according to FIG. 4;

FIG. 6a shows a top view of a drill head according to one embodiment of the present invention; and

FIG. 6b shows a partial sectional side view of the drill head shown in FIG. 6a.

### DETAILED DESCRIPTION OF THE INVENTION

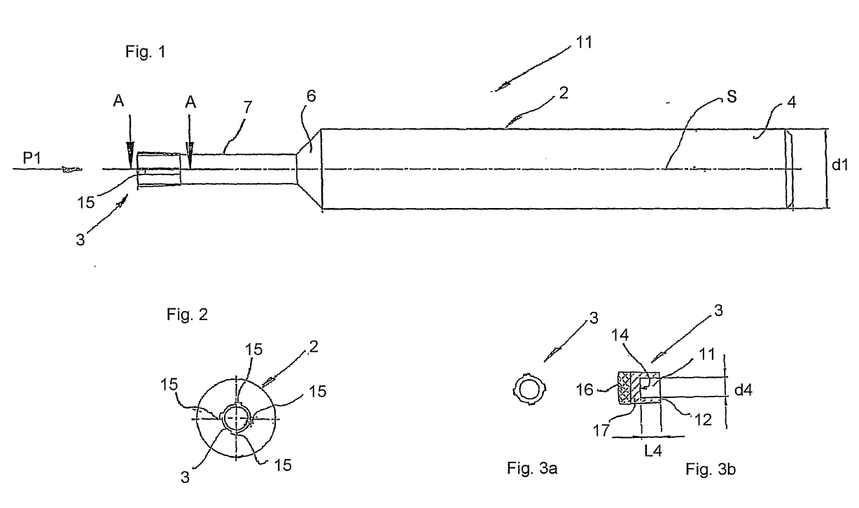

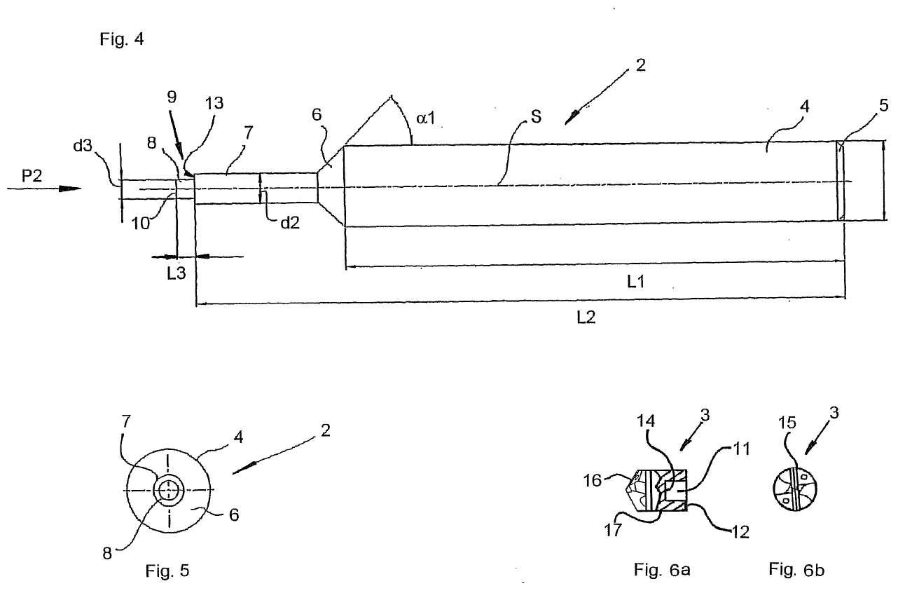

An exemplary embodiment of the tool according to the invention for cutting machining is shown, for example, as reamer 1. As shown in FIG. 1, a reamer 1 comprises a one-piece support part 2, made from a hard metal such as solid carbide, and, on the front section of the support part 2, a reamer head 3 is placed and is fitted with a fixed connection to the support part 2. In the exemplary embodiment shown in FIGS. 3a and 3b, the reamer head 3 is also in a single piece and consists uniformly of a super hard material, e.g. of cubic boron nitrite (CBN). The support part 2 may, for example, consist of a tool steel, a solid carbide or other materials, if necessary of a plurality of different materials. In principle a structure of different materials both of the support part 2 and the reamer head 3 is also possible, e.g. in the form of a layered structure or as a coated material.

For clamping in a tool support, the support part 2 has a cylindrical clamping section 4 with an outside diameter d₁, which has a chamfer 5 on the rear end of clamping section 4. In principle another design of the section on the tool for clamping in a tool support is also conceivable, e.g. in order to be able to be clamped in a drill chuck, a collet chuck or a collet.

At the front end of the clamping section 4, the support part 2 tapers over a round cone section 6 as far as a cylindrical extension section 7 with an outside diameter d₂ smaller than the outside diameter d₁. For example, in the exemplary embodiment shown, the outside diameter d₁ may be approx. 6 mm and the outside diameter d₂ may be approx. 2.2 mm. The inclination of the flank of the round cone section 6 may form an angle α₁ to a longitudinal axis S of the support part 2 and the reamer 1, or to the outside of the clamping section 4, which angle is approx. 45° in the example shown.

A tap section 8, with a circular cross-section, is provided concentrically to the extension section 7 at the front end of the extension section 7, which is arranged concentrically to the clamping section 4. Other cross-sectional shapes of the tap section 8 are also possible, which shapes may be adapted to a suitably recessed counter-section on the reamer head 3, as explained in more detail below. The tap section 8 is offset radially inwards relative to the extension section 7 over a shoulder 9 and has an outside diameter d₃ which is slightly smaller than the diameter outside d₂ of the extension section 7, here approx. 1.4 mm, for example. The tap section 8 has on its front end a flat end face 10 aligned essentially perpendicularly to the longitudinal axis S.

A prefabricated blank, for example, which is later machined to produce the reamer head 3, for completing the reamer 1, or the already fully completed reamer head 3 is placed on the support part 2 on the tap section 8, and is securely fixed to the support part 2. This may be achieved by different methods, for example by soldering, sintering, gluing, brazing, welding, etc.

After the reamer head 3 and a blank are fitted, the reamer 1 according to FIGS. 1 and 2 is produced. FIGS. 3a and 3b show in detail, as a component part, the reamer head 3 which is at least, for the most part, prefabricated. In order to be able to fasten the reamer head 3 securely and fixedly to the tap section 8 of the support part 2, the sections to be connected together each have a shape that is suitably matched to each other. In the example shown, the reamer head 3 has at its rear end a recess, which is formed here as a cylindrical pocket hole bore 11, which can be fixed securely by suitable connection methods to the support part 2. The reamer head 3 has two layers comprising a front hard layer 16 of CBN, with a layer thickness of approx. 1 mm, for example, and a rear base section 17 of hard carbide with a thickness of approx. 2 mm. In the embodiment shown, a depth 14 of pocket hole bore 11 in the longitudinal direction of the reamer head 3, at approx. 1.5. mm, is slightly greater, comparatively, than the axial length l₃ of the tap section 8, which is approx. 1.3 mm. Similarly, the inside diameter d₄ of the pocket hole bore 11, at approx. 1.5 mm, is slightly greater than the outside diameter d₃ of the tap section 8, at approx. 1.4 mm.

In particular, when the reamer head 3 is fully placed on tap section 8, an annular contact surface 12 at the rear end of the reamer head 3, bears flush or at least almost gap-free against a counter-surface 13 of the shoulder 9, which face is also annular. A gap region that may be formed may be filled, for example, with suitable soldering or adhesive material for soldering or gluing the reamer head 3 to tap section 8. Moreover, a circumferential annular gap and inner wall of pocket hole bore 11 is also provided for a soldered or glued joint due to the suitable dimensions of tap section 8 or of pocket hole bore, and a gap is also provided between the end face 10 of the tap section 8 and a base area 14 of the pocket hole bore 11.

In the direction of longitudinal axis S of the reamer 1 or of the support part 2, the length l₁ of the clamping section 4 may be more than half of the length l₂, which is obtained in the direction of the longitudinal axis S between the shoulder 9 and the rear end of support part 2 or the clamping section 4. In the exemplary embodiment shown, the length l₁ is approx. 36 mm and the length l₂ is approx. 47 m. In principle, however, other length ratios are possible, in particular different length ratios l₁ to l₂. Different diameter ratios d₁ to d₂ to d₃, in particular ratios of d₁ and d₂, are also possible.

The reamer head 3 is designed with four cutting edges 15, for example, i.e. with the four cutting edges 15 uniformly distributed over the circumference of reamer head 3. However, more or fewer cutting edges 15 may be formed on the reamer head 3. The reamer head 3 may be secured to the support part 2 as a preliminary product of the finished reamer head 3, for example as a green compact of a sinter material or as a blank eroded from a hard material, and can then be finished machined. In particular, the cutting edges 15 or rakes can be designed accurately for finish machining, e.g. by grinding.

It should be understood that the cutting edges 15 on the head 3 can be made having a variety of shapes. For example, as shown in FIGS. 6a and 6b, the cutting edges 15 can be formed along any surface of the head 3 depending on the intended use of the head 3. The head 3 shown in FIGS. 6a and 6b can be used as a drill head, for example. The head 3 shown in FIGS. 6a and 6b has two cutting edges 15, each extending from an outside diameter of the head 3 to form a point angle with the other cutting edge 15. It should be understood that more that two cutting edges 15 can be present.

Even with the differing cutting edge 15 arrangement, the head 3 shown in FIGS. 6a and 6b includes, for example, a front super hard layer 16 of CBN or PCD and a rear base section 17 of hard metal such as solid carbide. The head 3 of FIGS. 6a and 6b may have a pocket hole bore 11 and an annular contact surface 12 at a rear end of the head 3 so that a gap is provided between the end face of the tap section 8 and a base area 14 of the pocket hole bore 11.

1. A tool for cutting machining, the tool comprising:
a tool head having a plurality of tool cutting edges being arranged circumferentially about the tool head and consisting of the material of the tool head; and
a tool shaft having a clamping section for housing in a tool support,
wherein the tool head is fitted to the tool shaft as a separate part and consists of, in one piece, a hard material and at least one functional layer comprising at least one of a CBN and a PCD.

2. The tool for cutting machining, the tool comprising:
a tool head at least four tool cutting edges arranged circumferentially about the tool head, consisting of the material of the tool head, and having an outside diameter of up to 6 mm; and
a tool shaft with a clamping section for housing in a tool support,
wherein the tool head is fitted to the tool shaft as a separate part.

3. The tool according to claim 2, wherein the tool head consists of a hard material with at least one functional layer comprising at least one of a CBN and a PCD.

4. The tool according to claim 1, wherein the layers are sintered together in a layered structure of the hard material.

5. The tool according to claim 1, wherein the tool head comprises a recess for fitting to the tool shaft, the tool shaft comprises an insert section, and the tool head is connected to the tool shaft by inserting the insert section into the recess.

6. The tool according to claim 1, wherein the tool shaft further comprises a remachining unit formed thereon at a certain distance from the tool head in a longitudinal direction of the tool.

7. A method for producing a tool head for a tool for cutting machining, the method comprising:
providing a hard material tool head blank to a tool shaft; and
grinding partial regions of the hard material tool head blank to form a finished contour of the tool head, the finished contour comprising a plurality of tool cutting edges arranged circumferentially about the tool head.

8. The method according to claim 7 further comprising fixing the hard material tool head blank to a tool shaft before machining the finished contour of the tool head.

9. The method according to claim 7 further comprising working the hard material too head blank out of a hard material plate.

10. The method according to claim 8 further comprising working the hard material tool head blank out of a hard material plate.

11. The tool according to claim 2, wherein the layers are sintered together in a layered structure of the hard material.

12. The tool according to claim 2, wherein the tool head comprises a recess for fitting to the tool shaft, the tool shaft comprises an insert section, and the tool head is connected to the tool shaft by inserting the insert section into the recess.

13. The tool according to claim 2, wherein the tool shaft further comprises a remachining unit formed thereon at a certain distance from the tool head in a longitudinal direction of the tool.

14. A tool for cutting machining, the tool comprising:
a tool head having a plurality of tool cutting edges, each tool cutting edge extending from an outside diameter of said tool head to form a point angle with another of said tool cutting edges and consisting of the material of the tool head; and
a tool shaft having a clamping section for housing in a tool support,
wherein the tool head is fitted to the tool shaft as a separate part and consists of, in one piece, a hard material and at least one functional layer comprising at least one of a CBN and a PCD.

15. The tool according to claim 14, wherein the layers are sintered together in a layered structure of the hard material.

16. The tool according to claim 14, wherein the tool head comprises a recess for fitting to the tool shaft, the tool shaft comprises an insert section, and the tool head is connected to the tool shaft by inserting the insert section into the recess.

17. The tool according to claim 14, wherein the tool shaft further comprises a remachining unit formed thereon at a certain distance from the tool head in a longitudinal direction of the tool.
